(19) United States
(12) Patent Application Publication
(10) Pub. No.: US 2026/0151301 A1
(43) Pub. Date: Jun. 4, 2026

(54) Liquid Storage Bag Device

(71) Applicant: Alexis Hansen, Winnemucca, NV (US)

(72) Inventor: Alexis Hansen, Winnemucca, NV (US)

(21) Appl. No.: 19/366,946

(22) Filed: Oct. 23, 2025

Related U.S. Application Data
(60) Provisional application No. 63/727,312, filed on Dec. 3, 2024.

(51) Int. Cl. A61J 1/10; A61J 1/14

(52) U.S. Cl. CPC A61J 1/10; A61J 1/1468; A61J 1/1475; A61J 2200/50; A61J 2200/72; A61J 2200/76

(57) ABSTRACT

A liquid storage bag device is provided. The device is comprised of a liquid storage and dispensing device designed particularly for breastmilk, comprising a hollow, insulated body made of BPA-free, food-grade plastic or alternative materials to ensure safety and temperature retention. The body may adopt various shapes and includes features such as a resealable spout for pouring, a transparent viewing window with measurement lines for monitoring liquid levels, and optional decorative indicia for aesthetic appeal. It further includes a double-sealed zip flap or other secure closures for airtight storage, a writable surface for recording details, and a temperature indicator that may employ thermochromic strips or electronic sensors to provide real-time feedback.

### CROSS-REFERENCE TO RELATED APPLICATION

The present application claims priority to, and the benefit of, U.S. Provisional Application No. 63/727,312, which was filed on Dec. 3, 2024, and is incorporated herein by reference in its entirety.

### FIELD OF THE INVENTION

The present invention relates generally to the field of liquid storage bags. More specifically, the present invention relates to a liquid storage bag device, particularly for breastmilk, comprised of an insulated, BPA-free body with resealable spouts, transparent windows with measurement lines, and secure closures for safe and hygienic use. Additional features include writable surfaces for recording details and temperature indicators using thermochromic strips or electronic sensors for real-time liquid temperature monitoring. Accordingly, the present disclosure makes specific reference thereto. Nonetheless, it is to be appreciated that aspects of the present invention are also equally applicable to other like applications, devices, and methods of manufacture.

### BACKGROUND

Breast milk pumping plays a critical role in supporting parents who want to provide breast milk for their infants despite facing logistical or biological challenges. These challenges may include returning to work, being physically separated from the infant for extended periods, or managing supply fluctuations to ensure an adequate milk reserve. However, pumping breast milk can be a repetitive and time-consuming process, often accompanied by physical and emotional stress. Beyond the pumping itself, proper storage of the milk is a key concern, as breast milk requires careful handling to maintain its nutritional value and safety. Existing storage solutions, such as basic plastic bags, are functional to a degree but often lack features that streamline the experience for users. These conventional options may fail to adequately address critical needs, such as monitoring the milk's temperature, ensuring ease of transfer, or providing an uplifting and visually appealing design. As a result, individuals often find the process of storing breast milk frustrating and tedious, which may impact their overall pumping experience and willingness to continue. The limitations of current products point to the need for a more comprehensive, practical, and user-friendly solution.

Therefore, there exists a long-felt need in the art for a liquid storage bag device that is safe and hygienic for storing breast milk. There also exists a long-felt need in the art for a liquid storage bag device that includes functional features such as a resealable spout for easy milk transfer and a thermal sensor for monitoring milk temperature. Moreover, there exists a long-felt need in the art for the liquid storage bag device that incorporates visually appealing designs and motivational elements to enhance the user's experience during the pumping process.

The subject matter disclosed and claimed herein, in one embodiment thereof, comprises a liquid storage bag device. The device is comprised of a liquid storage and dispensing device designed particularly for breastmilk, comprising a hollow, insulated body made of BPA-free, food-grade plastic or alternative materials to ensure safety and temperature retention. The body may adopt various shapes and includes features such as a resealable spout for pouring, a transparent viewing window with measurement lines for monitoring liquid levels, and optional decorative indicia for aesthetic appeal. It further includes a double-sealed zip flap or other secure closures for airtight storage, a writable surface for recording details, and a temperature indicator that may employ thermochromic strips or electronic sensors to provide real-time feedback.

In this manner, the liquid storage bag device of the present invention accomplishes all the foregoing objectives and provides a safe, functional, and user-friendly solution for breast milk storage. Constructed from BPA-free, food-grade plastic, the device ensures hygienic storage and includes practical features such as a double-seal zip closure, a tear-open top, and a resealable flip spout for easy pouring. The integrated thermal sensor allows users to monitor the milk's temperature accurately, promoting optimal storage conditions. Additionally, the device's visually appealing designs and motivational messages offer a unique way to alleviate the monotony of pumping, creating a more positive and engaging experience. Thus, the liquid storage bag device provides a holistic solution for the challenges of breast milk storage and handling.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a liquid storage bag device. The device is comprised of a hollow body designed for storing and dispensing liquids, particularly breastmilk. The body may feature various shapes, such as cylindrical, rectangular, or ergonomically contoured designs, and is preferably made from BPA-free, food-grade plastic, though other materials may be used. Insulated materials, such as foam-based linings or reflective coatings, help maintain the liquid's temperature. The body may include decorative indicia to enhance aesthetic appeal and user engagement.

The body includes at least one spout for dispensing liquid, with a resealable flip-top spout being preferred. This design can feature a locking mechanism to secure the spout during transport or storage. Alternative spout configurations, such as twist-off or push-pull designs, may be used for versatility.

A transparent viewing window is incorporated into the body to allow users to monitor the liquid level. This window may include measurement lines in various units, and in some embodiments, the entire body or parts of it may be transparent.

The body may also feature a flap providing top access. This flap may utilize a double-sealed zip closure for airtight sealing or other fasteners such as snaps or magnetic closures. In some configurations, tear-able perforations may allow for simplified access. A writing area made of a dry-erase surface or label-compatible coating enables users to record information like names, dates, or liquid volumes.

A temperature indicator provides real-time feedback on the liquid's temperature. This may take the form of a color-changing strip using thermochromic materials to display temperature ranges visually or a battery-powered electronic module with a sensor to provide precise readings. In the electronic variant, the temperature is displayed on a digital screen or LED array and updates in real-time.

Accordingly, the liquid storage bag device of the present invention is particularly advantageous as it provides a safe, functional, and user-friendly solution for breast milk storage. Constructed from BPA-free, food-grade plastic, the device ensures hygienic storage and includes practical features such as a double-seal zip closure, a tear-open top, and a resealable flip spout for easy pouring. The integrated thermal sensor allows users to monitor the milk's temperature accurately, promoting optimal storage conditions. Additionally, the device's visually appealing designs and motivational messages offer a unique way to alleviate the monotony of pumping, creating a more positive and engaging experience. Thus, the liquid storage bag device provides a holistic solution for the challenges of breast milk storage and handling. In this manner, the liquid storage bag device overcomes the limitations of existing liquid storage bags known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a liquid storage bag device of the present invention while unfolded in accordance with the disclosed architecture; and

FIG. 2 illustrates a perspective view of one potential embodiment of a liquid storage bag device of the present invention while folded in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a liquid storage bag device that is safe and hygienic for storing breast milk. There also exists a long-felt need in the art for a liquid storage bag device that includes functional features such as a resealable spout for easy milk transfer and a thermal sensor for monitoring milk temperature. Moreover, there exists a long-felt need in the art for the liquid storage bag device that incorporates visually appealing designs and motivational elements to enhance the user's experience during the pumping process.

The present invention, in one exemplary embodiment, is comprised of a liquid storage bag device. The device is comprised of a hollow body for storing and dispensing liquids, particularly breastmilk. The body may have various shapes, such as cylindrical, rectangular, or ergonomically contoured designs, and is preferably made of BPA-free, food-grade plastic, though alternative materials may be used. Insulated materials, such as foam-based linings or reflective coatings, help maintain the liquid's temperature. Decorative indicia may be included to enhance its aesthetic appeal and engage users.

The body incorporates at least one spout for dispensing liquid, with a resealable flip-top spout being the preferred design. This spout may include a locking mechanism to secure it during transport or storage. Alternative spout options, such as twist-off or push-pull designs, provide additional versatility.

A transparent viewing window is included to allow users to monitor the liquid level. This window may feature measurement lines in various units, and in some embodiments, portions or the entirety of the body may be transparent.

The body may also include a flap for top access, which may utilize a double-sealed zip closure for airtight sealing or other fasteners like snaps or magnetic closures. Certain configurations may also feature tear-able perforations for simplified access. A writing area made from a dry-erase surface or label-compatible coating allows users to record details such as names, dates, or liquid volumes.

A temperature indicator is included to provide real-time feedback on the liquid's temperature. This may be a color-changing strip made of thermochromic materials for visual temperature ranges or a battery-powered electronic module with a sensor for precise readings. In the electronic version, the temperature is displayed on a digital screen or LED array with real-time updates.

The liquid storage bag device offers a safe, functional, and user-friendly solution for breastmilk storage. Made from BPA-free, food-grade plastic, it ensures hygienic storage and includes features such as a double-sealed zip closure, a tear-able top, and a resealable spout for convenient pouring. An integrated thermal sensor allows users to monitor the milk's temperature accurately, ensuring optimal storage conditions. The visually appealing design and motivational messages add to the user experience and make the device a comprehensive solution for breastmilk storage and handling, addressing the limitations of existing liquid storage bags.

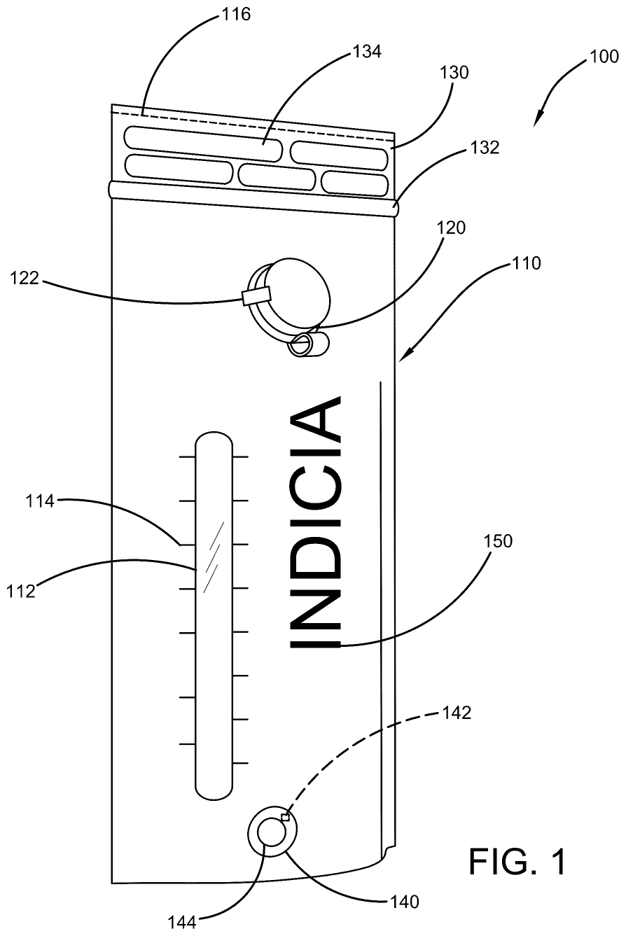

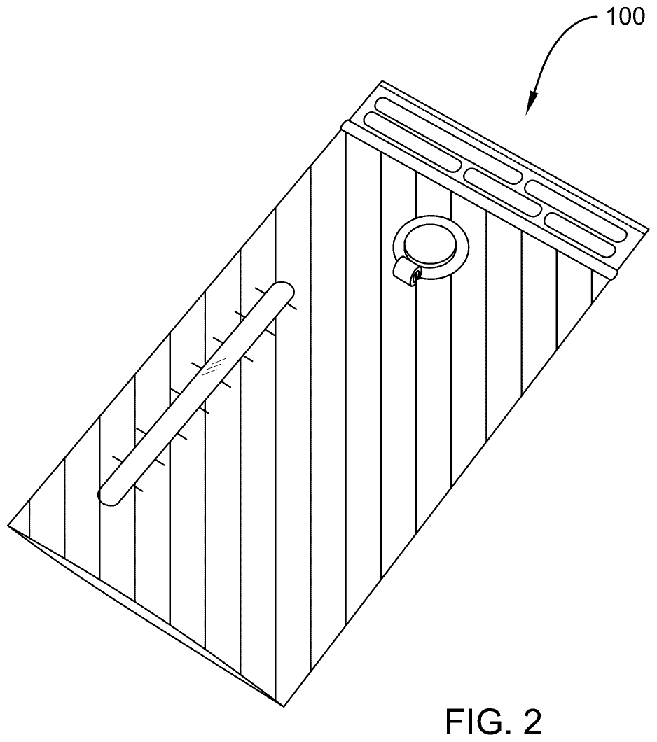

Referring initially to the drawings, FIG. 1 illustrates a perspective view of one potential embodiment of a liquid storage bag device 100 of the present invention while unfolded in accordance with the disclosed architecture. The device 100 is comprised of a hollow body 110 that is designed for storing and dispensing liquids, with a particular focus on storing breastmilk. The body 110 may take on various shapes, including, but not limited to, cylindrical, rectangular, or ergonomically contoured designs. The body 110 is preferably manufactured using a BPA-free, food-grade plastic to ensure safety and hygiene, but it may also be made of alternative materials. Furthermore, the material used for the body 110 is insulated to maintain the temperature of the liquid inside. The insulated body material 110 may be comprised of a foam-based lining, reflective coating, etc., making the device 100 particularly effective at keeping breastmilk warm. The body 110 may also be comprised of at least one indicia 150, which may include decorative patterns, motivational sayings, humorous messages, or branding elements. The indicia 150 enhances the aesthetic appeal of the device and may also serve to engage users more effectively. When not in use, the device 100 folds flat, as seen in FIG. 2.

The body 110 is comprised of at least one spout 120. The spout 120 is preferably designed as a resealable flip-top pour spout, allowing a user to pour stored liquid from the device 100. This flip-top design may include a locking mechanism 122 to ensure the spout 120 remains securely closed during transportation or storage, as seen in FIG. 1.

In addition to the flip-top design, other configurations of the spout 120 may be utilized to address various user preferences and requirements. For example, a twist-off spout 120 having a threaded mechanism that creates a tight seal when closed while allowing for easy opening and closing. Similarly, a push-pull spout 120 could be incorporated, providing a mechanism that allows users to open and close the spout 120 with a simple push or pull motion for quick and efficient access to the liquid.

To enhance usability, the body 110 is comprised of at least one transparent viewing window 112 that allows users to visually monitor the level of liquid stored within the body 110. The window 112 is preferably positioned along the front of the body 110 (as seen in FIG. 1) but maybe positioned at any location on the body 110. The viewing window 112 may further include at least one set of measurement lines 114, which enable users to gauge the liquid volume within the body 110 in units such as ounces, fluid ounces, liters, or milliliters. The measurement lines 114 may feature varying increments to meet specific user needs in different embodiments. In one embodiment, the entire body 110 or multiple areas of the body 110 may be transparent.

The body 110 may also be comprised of at least one flap 130, which provides top access to the body 110. The flap 130 is preferably a double-sealed zip flap, as seen in FIG. 1, to ensure an airtight and leakproof closure. In alternative embodiments, the flap 130 may be secured using at least one fastener 132, which could include options such as, but not limited to, snaps, hook and loop, or magnetic closures. Additionally, the body 110 may incorporate at least one tear-able perforation 116, allowing users to access the contents of the body 110 by tearing and discarding a portion of the body 110.

The flap 130 (or in different embodiments, any other area of the body 110) is further comprised of at least one writing area 134. The writing area 134 is made of a writable surface, such as a dry-erase material or a label-compatible coating, enabling users to record important information directly on the device 100. This information may include, but is not limited to, name, date, time, or liquid volume.

To assist users in monitoring the temperature of the liquid within the device, the body 110 is also comprised of at least one temperature indicator 140. The temperature indicator 140 may take various forms, each designed to provide real-time feedback on the liquid's temperature to enhance usability and ensure safety.

In one embodiment, the temperature indicator 140 may be a color-changing strip, which is affixed to the outer surface of the body 110 or integrated within a transparent section of the body 110. The strip 140 provides a visual cue regarding the temperature of the liquid contained within the body 110. For example, the strip may display a first color to signify that the liquid is too cold (e.g., below 68 degrees Fahrenheit), a second color to indicate the temperature is within a general safe range (e.g., between 68 and 104 degrees Fahrenheit), a third color to denote optimal temperature (e.g., precisely 98.6 degrees Fahrenheit), and a fourth color to warn that the liquid is too hot (e.g., above 104 degrees Fahrenheit). The strip 140 may be constructed from thermochromic materials that react reliably to specific temperature thresholds.

In an alternative embodiment, the temperature indicator 140 may be in the form of a battery-powered electronic module that provides precise temperature readings. In this embodiment, the indicator 140 may include at least one temperature sensor 142, such as a thermistor or thermocouple, to continuously monitor the liquid's temperature. The temperature sensor 142 is in thermal contact with the liquid during use of the device 100, ensuring accurate measurements. The indicator 140 may display the temperature on a display 144 such as, but not limited to, a digital screen or through an LED array integrated into the body 110. The display 144 may update in real-time to reflect temperature changes.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “liquid storage bag device” and “device” are interchangeable and refer to the liquid storage bag device 100 of the present invention.

Notwithstanding the foregoing, the liquid storage bag device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the liquid storage bag device 100 as shown in the FIGS. are for illustrative purposes only, and that many other sizes and shapes of the liquid storage bag device 100 are well within the scope of the present disclosure. Although the dimensions of the liquid storage bag device 100 are important design parameters for user convenience, the liquid storage bag device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A liquid storage bag device comprising:
a hollow body comprising:
an insulated material configured to maintain a temperature;
a spout;
a transparent viewing window, wherein the viewing window further comprises a measurement line; and
a flap providing top access to the hollow body, the flap configured to create an airtight and leakproof seal.

2. The liquid storage bag device of claim 1, wherein the insulated material is comprised of a foam-based lining.

3. The liquid storage bag device of claim 1, wherein the insulated material is comprised of a reflective coating.

4. The liquid storage bag device of claim 1, wherein the flap is comprised of a double-sealed zip flap.

5. The liquid storage bag device of claim 1, wherein the spout is comprised of a flip-top pour spout.

6. The liquid storage bag device of claim 1, wherein the measurement line displays a volume in a unit of an ounce, a fluid ounce, a liter, or a milliliter.

7. A liquid storage bag device comprising:
a hollow body comprising:
an insulated material configured to maintain a temperature;
a spout comprised of a locking mechanism;
a temperature indicator;
a writing area comprising a writable surface;
a transparent viewing window, wherein the viewing window further comprises a measurement line; and
a flap providing top access to the hollow body, the flap configured to create an airtight and leakproof seal.

8. The liquid storage bag device of claim 7, wherein the temperature indicator is comprised of a digital display.

9. The liquid storage bag device of claim 7, wherein the temperature indicator is comprised of an LED display.

10. The liquid storage bag device of claim 7, wherein the temperature indicator is comprised of a sensor.

11. The liquid storage bag device of claim 9, wherein the temperature indicator is comprised of a sensor.

12. The liquid storage bag device of claim 7, wherein the spout is comprised of a flip-top pour spout, a twist-off spout, or a push-pull spout.

13. The liquid storage bag device of claim 7, wherein the writing area is comprised of a dry-erase material.

14. A liquid storage bag device comprising:
a hollow body comprising:
an insulated material configured to maintain a temperature;
a spout comprised of a locking mechanism;
a temperature indicator comprised of a color-changing strip;
a writing area comprising a writable surface;
a transparent viewing window, wherein the viewing window further comprises a measurement line; and
a flap providing top access to the hollow body, the flap configured to create an airtight and leakproof seal.

15. The liquid storage bag device of claim 14, wherein the color-changing strip is comprised of a thermochromic material.

16. The liquid storage bag device of claim 14, wherein the flap is comprised of a fastener.

17. The liquid storage bag device of claim 16, wherein the fastener is comprised of a snap, a hook and loop, or a magnet.

18. The liquid storage bag device of claim 14, wherein the hollow body is comprised of a tear-able perforation.

19. The liquid storage bag device of claim 14, wherein the hollow body is comprised of a BPA-free material.

20. The liquid storage bag device of claim 14, wherein the temperature indicator is positioned on an outer surface of the body.
